(19) United States
(12) Patent Application Publication
(10) Pub. No.: US 2009/0228492 A1
(43) Pub. Date: Sep. 10, 2009

(54) APPARATUS, SYSTEM, AND METHOD FOR TAGGING MEDIA CONTENT

(75) Inventors: John P. VALDEZ, Flower Mound, TX (US); Yohan RAJAN, Flower Mound, TX (US); Ai-Sheng MAO, Richardson, TX (US)

Correspondence Address: VERIZON;PATENT MANAGEMENT GROUP, 1320 North Court House Road, 9th Floor, ARLINGTON, VA, 22201-2909, US

(73) Assignee: Verizon Data Services Inc., Temple Terrace, FL (US)

(21) Appl. No.: 12/045,504

(22) Filed: Mar. 10, 2008

(51) Int. Cl. G06F 17/30

(52) U.S. Cl. 707/10; 707/101; 707/E17.005

(57) ABSTRACT

An approach for tagging media content (e.g., audio/video content) such that the tag call be used to access or manipulate the media content associated with the tag at a later time. A command is received from a user to request marking of the media content. A tag is automatically inserted therein based on predetermined criteria in response to the command. The media content can be accessed at a point specified by the tag.

### BACKGROUND INFORMATION

Present day customers can readily access a vast supply and variety of audio/video content. For example, live audio/video content can be received via a broadcast network, a cable network, Verizon® FiOS® network, satellite network, an internet protocol television (IPTV) system, an internet protocol video system, a wireless network, etc. Additionally, previously recorded audio/video content is available from numerous sources and services providers, such as digital video recorders (DVRs), video-on-demand services, etc. Furthermore, the advent of readily-available, cost-effective broadband services has vastly increased the capabilities of customers to access such content. However, despite the increased availability of such audio/video content, the customer has not been provided with tools to effectively sort through and utilize the content from these vast content resources.

Therefore, there is a need for an approach that provides the customer with the ability to access and utilize the content in a more effective manner.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system incorporating a video tagging system capable of allowing a user to tag various forms of media content for later retrieval and/or manipulation, according to an exemplary embodiment;

FIG. 2 is a diagram of the video tagging system interconnected to a media content source system;

FIG. 3 is a flowchart of a process for receiving, authorizing, and validating a user event command, according to an exemplary embodiment;

FIG. 4 is a flowchart of a process for tagging audio/video content, according to an exemplary embodiment;

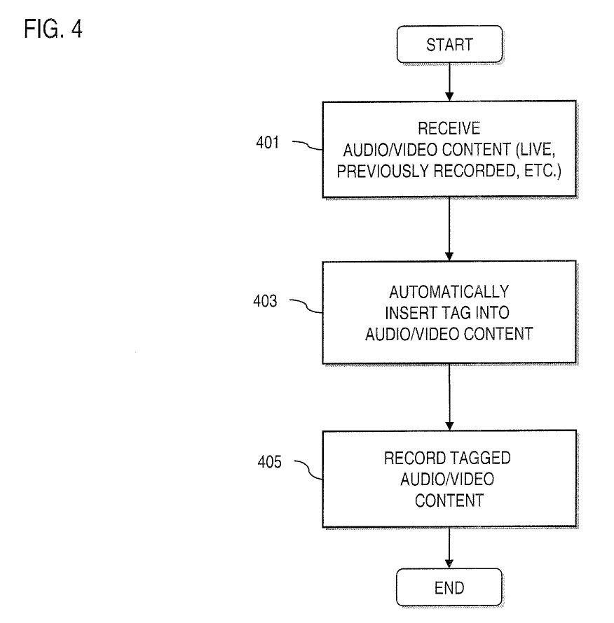

FIG. 5 is a flowchart of a process for receiving a tag command, tagging audio/video content, and constructing a table for allowing a user to quickly search for and access the tagged audio/video content, according to an exemplary embodiment; and

FIG. 6 is a diagram of a computer system that can be used to implement various exemplary embodiments.

### DETAILED DESCRIPTION OF THE PREFERRED EMBODIMENTS

An apparatus, method, and system for tagging audio/video content such that the tag can be used to access or manipulate the content associated with the tag at a later time are described. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

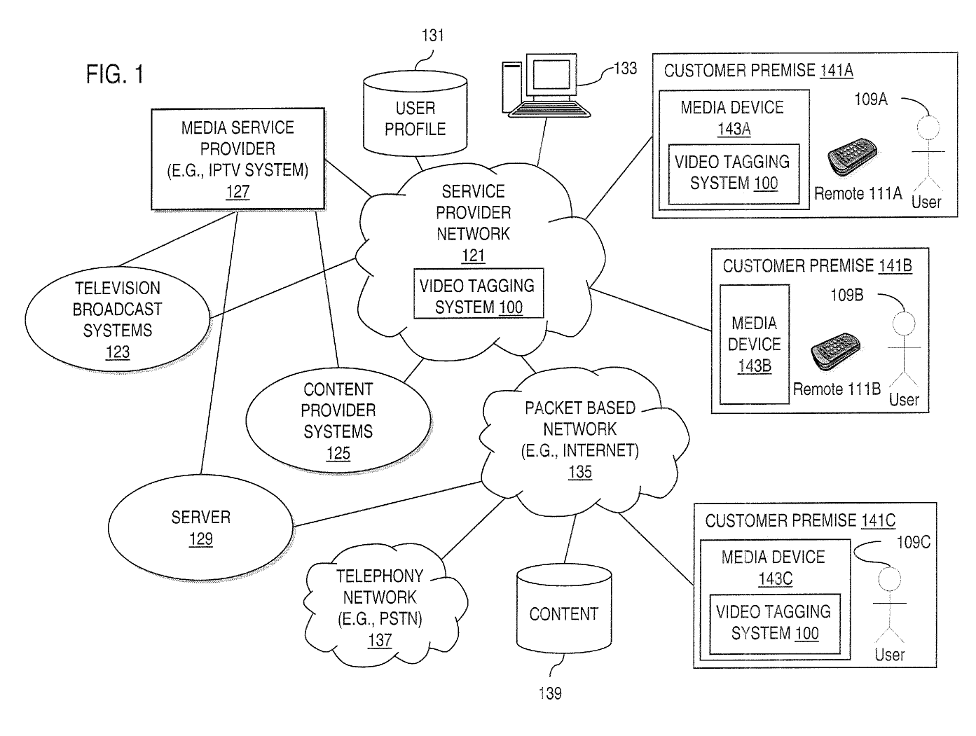

FIG. 1 depicts a media content source system (or multimedia system) that incorporates tagging systems 100 that can provide an end user with the ability to tag (or bookmark or mark) specific points or segments of interest within any type of multimedia content, and thereby provide the user with an easy way to access and/or otherwise manipulate the tagged content at any later point in time.

The media content source system depicted in FIG. 1 includes a service provider network 121 that integrates telecommunications, computing, and media environments, to provide a broad scope of devices and sources available to individuals for receiving a broad range of media content, and the tagging system 100 provides the user with the ability to easily access and enjoy this wealth of media content. For example, an individual user 109A, 109B, 109C can tune into a televised media program or a webcast using a media device 143A, 143B, 143C (e.g., a set top box, personal computer, video game system, web-appliance, etc.) at the customer premise 141A, 141B, 141C, in order to access media content such as movies, television shows, sporting events, etc. Moreover, the user can have access to the video tagging system 100, which can be provided at the customer premise (e.g. as in the media devices 143A and 143C at customer premises 141A and 141C, respectively) or at a remote location within the media content source system (e.g. provided at the service provider network 121) that is accessible by a user from the customer premise (e.g., as is the case with media device 143B at customer premise 141B), and thus the user can utilize the tagging system 100 to tag the media content from the media content system.

In the depicted embodiment, a plurality of media devices 143A-143C are configured to communicate with and receive signals and/or data streams, e.g., media content, from a media service provider (MSP) 127 or other transmission facility. Exemplary MSPs 127 may comprise one or more media content servers (not illustrated) and/or data repositories (not shown). Alternatively, the servers and/or repositories may be accessed via one or more service provider networks 121 or packet-based networks 135, such as user profile repository 131, content repository 139, or server 129. Further, a service provider network 121 may include a system administrator 133 for operational and management functions to deploy the displayable application services using, for instance, an internet protocol television (IPTV) system. In this manner, the media devices 143A-143C may utilize any appropriate technology to draw, receive, or transmit media content from/to a service provider 127 or other content source/sink.

Media content generally includes audio-visual content (e.g., broadcast television programs, VOD programs, pay-per-view programs, IPTV feeds, DVD related content, etc.), pre-recorded media content, data communication services content (e.g., commercials, advertisements, videos, movies, songs, images, sounds, etc.), Internet services content and/or other equivalent media forms. In this manner, a service provider 127 may provide (in addition to their own media content) content obtained from sources, such as one or more television broadcast systems 123, one or more third-party content provider systems 125, content residing in a repository 139 or server 129 accessible over a packet-based network 135, or available via one or more telephony networks 137, etc.

Exemplary embodiments enable MSPs 127 to transmit and/or interlace content retrieved over, for instance, the packet-based network 135 and augmented content with conventional media content streams. In alternative embodiments, the media devices 143A-143C may be concurrently configured to draw/receive/transmit content from (or to) multiple sources, thereby alleviating the burden on any single source, e.g., service provider 127, to gather, supply, or otherwise meet the content demands of any user or site. Thus, particular embodiments enable authenticated third-party television broadcast systems 123, content provider systems 125, or servers 129 to transmit media content to the media devices 143A-143C either apart from, or in conjunction with, service provider 127.

Accordingly, the media devices 143A-143C may communicate with MSPs 127, television broadcast systems 123, third-party content provider systems 125, or servers 129 via one or more service provider networks 121. These networks may employ various access technologies (including broadband methodologies) including, but certainly not limited to, cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., radio networks), terrestrial broadcasting networks, provider specific networks (e.g., a Verizon® FIOS® network, a TiVo® network, etc), and the like.

Further, content may be obtained from (or to) one or more packet-based networks 135 or telephony networks 137, such as the Internet, various intranets, local area networks (LAN), wide area networks (WAN), the public switched telephony network (PSTN), integrated services digital networks (ISDN), other private packet switched networks or telephony networks, as well as any additional equivalent system or combination thereof. These networks may utilize any suitable protocol supportive of data communications, e.g., transmission control protocols (TCP), internet protocols (IP), file transfer protocols (FTP), telnet, hypertext transfer protocols (HTTP), asynchronous transfer mode (ATM), socket connections, Ethernet, frame relay, and the like, to connect the media devices to the various content sources. In alternative embodiments, the media devices may be directly connected to the one or more various content sources, including service provider 127.

In various embodiments, the service provider network 121 may include one or more video processing modules (not shown) for acquiring and transmitting video feeds from service provider 127, the television broadcast systems 123, other third-party content provider systems 125, or servers 119 over one or more of the networks 121, 135, 137 to particular media devices 143A-143C. Further, service provider network 121 can optionally support end-to-end data encryption in conjunction with video streaming services such that only authorized users are able to view content and interact with other legitimate users/sources.

In particular embodiments, service provider 127 may comprise an IPTV system configured to support the transmission of television video programs from the broadcast systems 121 as well as other content, such as overlay instances from the various third-party sources (e.g., 123, 125, 129) utilizing Internet Protocol (IP). That is, the IPTV system may deliver video streams, including overlay and augmented data, in form of IP packets. Further, the transmission network (e.g., service provider network 121) may optionally support end-to-end data encryption in conjunction with the video streaming services, as mentioned earlier.

In this manner, the use of IP permits television services to be integrated with broadband Internet services, and thus, share common connections to a user site. Also, IP packets can be more readily manipulated, and therefore, provide users with greater flexibility in terms of control and offers superior methods for increasing the availability of content including overlay and augmented content. Delivery of video content, by way of example, may be through a multicast from the IPTV system 127 to the media devices. Any individual media device may tune to a particular source, e.g., channel, by simply joining a multicast of the video content, utilizing an IP group membership protocol (IGMP). For instance, the IGMP v2 protocol may be employed for joining media devices to new multicast groups. Such a manner of video delivery avoids the need for expensive tuners to view television broadcasts; however, other video delivery methods, such as cable, may still be used. It should be noted that conventional delivery methods may still be implemented and combined with the above delivery methods. Also, the video content may be provided to various IP-enabled media devices, such as PCs, PDAs, web-appliances, mobile phones, etc.

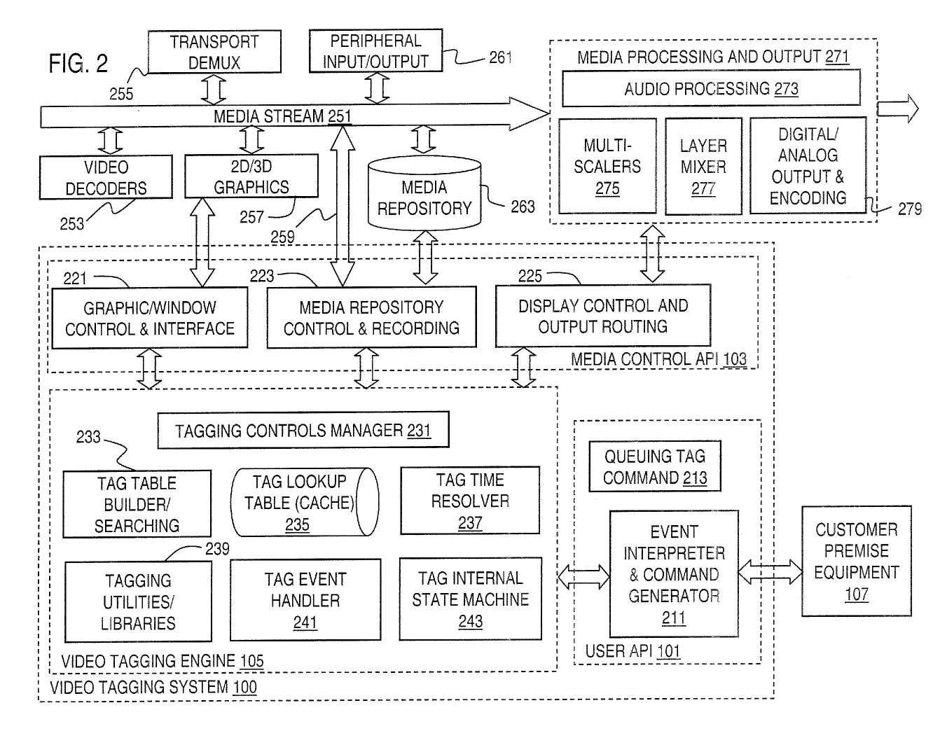

Thus, FIG. 1 depicts a system that incorporates a video tagging system (VITAS) 100, which can be provided at a customer premise or at a remote location connected to the overall system (such as at the servicer provider network) so that a user can access and used the remote tagging system. As further shown in FIG. 2, the tagging system 100 can include three major sub-systems, namely, a User application programming interface (API) 101, a Media Control API 103, and a Video Tagging Engine (VTE) 105. A system equipped with the tagging system 100 can be invoked and controlled by a variety of customer premise equipment (CPE) 107, for example, media devices 143A-143C such as a set-top box or a personal computer, an infrared (IR) or radio frequency (RF) remote control unit 111A-111B, and a pointer device, etc. with or without accelerometers or gyroscopes for motion sensitive control. A user can use the CPE 107 to invoke and control the tagging system 100, which then interacts with a Multimedia System 113. The User API 101 controls the interaction between the CPE 107 and the tagging engine 105, and the Media Control API 103 controls the interaction between the VTE and the Multimedia System 113.

The video tagging system 100 provides an end user with the ability to tag (or bookmark or mark) specific points or segments of interest within any type of multimedia content, and thereby provides the user with an easy way to access and/or otherwise manipulate the tagged content at any later point in time. The tagging system can be used to tag all types of streaming audio/video content that is live or previously recorded. By way of illustration, the system can be used to tag live television content (e.g., via broadcast network, cable network, Verizon® FIOS® network, satellite network, an IPTV system, internet protocol video system, wireless network, etc.), real-time audio/video streams that are being recorded, content previously recorded (e.g., on a digital video recorder (DVR), or video-on-demand services, etc.), or various other content streams. The terminology “audio/video” used in the present description refers to content that includes audio and/or video content. Additionally, multimedia content generally includes audio-visual content (e.g., broadcast television programs, video-on-demand programs, pay-per-view programs, IPTV feeds, DVD related content, etc.), pre-recorded media content, data communication services content (e.g., commercials, advertisements, videos, movies, songs, images, sounds, etc.), Internet services content and/or other equivalent media forms.

One exemplary use of the tagging system is in conjunction with a videoconferencing network, such as a Verizon® internet protocol video system (VZ IPVS), which is a networked consumer electronic system that can provide users with the ability to, for example, videoconference with one or more parties over a secure internet protocol (IP) network, and/or monitor homes or businesses in real-time with high quality H.264 (MPEG4 Part 10/AVC) video streams at 30 frames per second (fps) using high and low resolution multi-media IP cameras connected to a media control sub-system, called a media control unit (MCU), either via wired or wireless broadband networks. The tagging system can provide the end user with the ability to record the live audio/video streams from the home or business monitoring cameras on the MCU, and playback or otherwise manipulate the recorded content at a convenient time. The tagging system can allow the end user to manually and/or automatically insert one or more tags into the live audio/video stream and record the tagged content for later user, and/or record the live audio/video stream in an untagged state for later tagging.

The MCU can act as a central control unit that supports a variety of audio and video output devices. The MCU can be provided with a hard disk drive (HDD) that acts as a media repository by storage media content, which can allow the audio and video being multicasted from the cameras of the VZ IPVS to be recorded for later playback and viewing. The video content can be displayed on a display device (e.g., television, monitor, projector, etc.) connected to the MCU. The display device can also provide for audio playback by having internal or external audio output capabilities. The MCU can be configured to record and/or playback individual audio/video streams, or multiple streams of content simultaneously.

While viewing live or previously recorded audio/video content, it is desirable to be able to quickly jump directly to a particular scene or point in time within the content. The tagging system allows the user to tag and later quickly access or manipulate any particular section of the audio/video content, without having the review the content in its entirety by manually fast forwarding, rewinding or skipping through units of the entire content. The tagging system can accomplish this by inserting tags (or bookmarks or markers) on video/audio content that identifies start and end points for a particular segment of interest within the content. Such tags are separate from other meta information embedded in the content.

The tagging system can provide at least two general ways in which multimedia content can be tagged; namely, live content tagging and recorded content tagging. In live content tagging, live media sessions (e.g., live audio/video streaming via the cameras of the VZ IPVS, broadcast network, cable network, Verizon® FiOS® network, satellite network, IPTV system, wireless network, etc.) are tagged either automatically based upon specified criteria (i.e. preset tagging events defined by time scheduling, security events, or other methods), or manually by a user inserting the tags. In recorded content tagging, the recorded content can be tagged either automatically based upon specified criteria, or manually by the user inserting the tags while the recorded content is being viewed. The tag can include a starting tag, or both a start tag and an end tag. The tagging can be based on, for instance, the viewing behavior of the user (e.g., a child)—e.g., first 20 seconds of the video content that is viewed.

Automatic tagging of live or recorded media content can be based upon specified criteria. The tagging system can automatically add tag information to the video content and the tagged video content can be stored for later access and/or manipulation. The specified criteria can include preset tagging events defined by time scheduling or other methods. And the user can select which specified criteria from a list of criteria are active at a given time or for a given media content. Alternatively, the tagging system can automatically insert chapter indexing in a video encoding stream. For example, indexing can be automatically inserted using a video encoder input connected to a video camera, which inserts a chapter index based on certain events, such as the number of frames or the number of pixels that change in a frame. Such indexing would allow the user to directly access a portion of the audio/video that has changed, for example, so that a security camera can detect security events, such as motion or other changes in the video content.

Manual tagging of a live or recorded content can be actuated by the user, while the user is viewing or listening to the live or recorded media content. For example, the user may want to tag a particular event, and add descriptive information to the tag, such as “Baby rolled over for the first time” or “Water leak first detected.” This tagging can be accomplished in a variety of ways. For example, the user can tag a particular event by pausing the audio/video content during viewing using a remote control unit, accessing an on-screen keyboard, and entering the relevant tag information corresponding to the segment being tagged. Alternatively, the user can tag a particular event without pausing the content. Various fields can be provided to describe the tag, such as manually populated fields of information (e.g., title, description, etc.) and auto-populated fields of information (e.g., date, time, etc.).

FIG. 2 depicts the video tagging system 100 that is interconnected to a media content source. As depicted in FIG. 2, the User API 101 can include an Event Interpreter and Command Generator (EICG) 211 and a Queuing Tag Command unit 213. The Media Control API 103 can include a Graphic/Window Control and Interface unit 221, a Media Repository Control and Recording unit 223, and a Display Control and Output Routing unit 225. The tagging engine 105 can include a Tagging Control Manager 231, a Tag Table Builder/Searching unit 233, a Tag Lookup Table 235, a Tag Time Resolver 237, a Tagging Utilities/Libraries unit, a Tag Event Handler 241, and a Tag Internal State Machine 243. Each of the three sub-systems will be described in greater detail below.

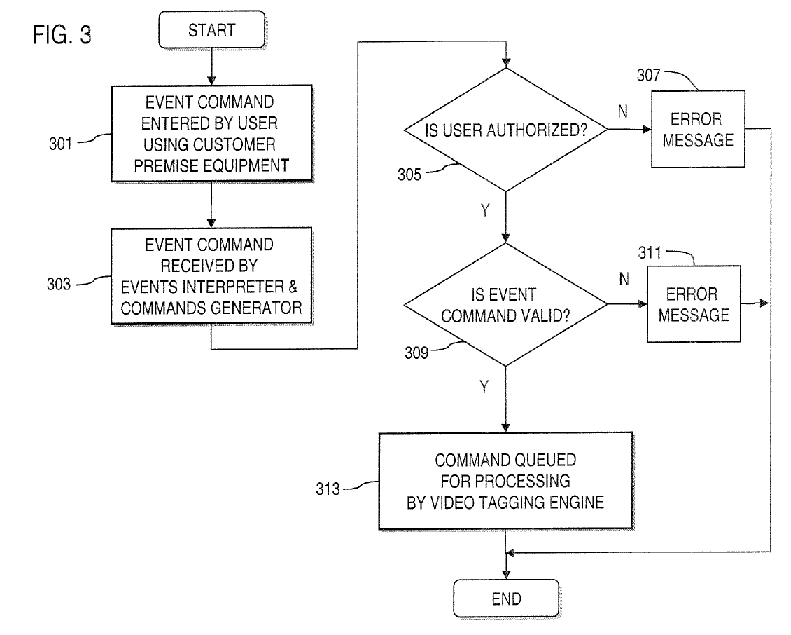

As shown in a flowchart in FIG. 3, in step 301, the user can invoke or control the tagging system 100 by entering a user event command using the CPE 107. In step 303, the EICG 211 of the User API 101 sub-system receives and handles the user event command from the CPE 107. Primarily, the EICG 211 first validates the user event command and recognizes it, enhanced by the customized rules of authentication, authorization, and accounting in order to provide a secure front-end to the system.

Thus, in order to provide a secure front-end of the system, the EICG 211 first queries in step 305 whether the user is an authorized user of the system using the rules of authentication, authorization, and accounting. If the answer to the query raised in step 305 is No, then the EICG 211 issues an error message at step 307 indicating that the user is unauthorized and the process ends. If the answer to the query raised in stop 305 is Yes, then the EICG 211 continues to step 309.

Then, the EICG 211 attempts to validate the user event command entered by the user. Thus, in step 309 the EICG 211 queries whether the user event command is a valid command. The interpretation of a user event command that results in a defined VITAS command is referred to as event-command mapping. The event-command mapping is implemented by an event-command look up table stored in the EICG 211, which facilitates stream-lined, and ordered event processing. Thus, the EICG 211 compares the user event command from the CPE 107 with the VITAS command set list stored within the event-command lookup table to determine whether the user event command is valid. An example of such a VITAS command set list includes the following (as shown in Table 1):

TABLE 1

VITAS_StartTags( ), VITAS_SaveTags( ), VITAS_StopTags( ),
VITAS_PurgeTags( );
VITAS_ShowTags_Menu( ), VITAS_Hide_Tags_Menu( ),
VITAS_ShowTags_Mosaic( ),
VITAS_ShowTags_Icons( ), VITAS_HideTags_Icons( );
VITAS_PlayTaggedVideoAudio( ), VITAS_StopTaggedVideoAudio( ),
VITAS_CopyTaggedVideoAudio( ),
VITAS_PlayTaggedVideoOnly( ); and
VITAS_CreateTaggedVideoAudio_Album,
VITAS_DeleteTaggedVideoAudio_Album,
VITAS_CreateTaggedSnapshot_Album,
VITAS_DeleteTaggedSnapshot_Album.

Thus, the tagging system can provide enriched tag commands that provide the user with a variety of features to manipulate the tagged recorded audio/video content. For example, enriched tag commands can be provided to command: start, stop, save, purge, hide, and show multiple tags; show and hide the tag menu, mosaics and icons; create and delete the tagged audio/video albums; create and delete the tagged audio/video snapshot albums; and play and stop a tagged audio/video.

If the answer to the query raised in step 309 is No, then the EICG 211 issues an error message at step 311 indicating that the command is invalid and the process ends. If the answer to the query raised in stop 305 is Yes, then the EICG 211 continues to step 313, where the authorized and validated user event command is queued by the queuing tag command unit 213 for processing by the tagging engine 105. Thus, the VITAS command generated by the event-command mapping is queued for further processing by the tagging engine 105 sub-system.

The tagging system Media Control API 103 subs-system interacts with the Multimedia System 113 in a manner based on the user's requests. The Multimedia System 113 for use with the tagging system 100 typically requires, at a minimum, one or more Video Decoders 253, a Transport Demultiplexer 255, 2D/3D Graphics 257, a Media Repository 263, and a Media Processing and Output Unit 271. In addition, an optional Peripheral Input/Output 261 can be provided in the Multimedia System 113. The Media Processing and Output Unit 271 can include an Audio Processing unit 273, Multi-Scalers 275, a Layer Mixer 277, and a Digital/Analog Output and Encoding unit 279, and can provide an output for a display unit. All of the components of the multimedia system 113 interact with a Media Stream 251, which can be, for example, a live stream of audio/video (e.g. live audio/video streaming via the cameras of the VZ IPVS, broadcast network, cable network, Verizon® FiOS® network, satellite network, IPTV system, wireless network, etc.), playback of recorded audio/video content from the Media Repository 263, or live or recorded content from other media content sources/servers/repositories.

As mentioned above, the Media Control API 103 can include three components, namely, a Graphic/Window Control and Interface unit 221, a Media Repository Control and Recording unit 223, and a Display Control and Output Routing unit 225. The Graphic/Window Control and Interface unit 221 is responsible for (i) drawing the VITAS tag icons and tag menus, (ii) rendering windows, and (iii) numerically computing 2D/3D graphic views, transformations, and projections. The Media Repository Control and Recording unit 223 can access the Media Stream 251 directly via pathway 259. The Media Repository Control and Recording unit 223 controls access to the Media Repository 263 for recording and retrieving of tagged audio/video. The Display Control and Output Routing unit 225, in cooperation with the Graphic/Window Control and Interface unit 221, provides the functionalities of scaling tagged video, mixing the scaled tagged video with the graphics and windows of the tag icons and tag menus, and outputting the results to a display unit via the Media Processing and Output Unit 271.

The core of the tagging system 100 is the tagging engine 105 sub-system. In the most basic description of the tagging engine 105 operation, the tagging engine 105 receives audio/video content as in step 401, automatically inserts a tag into the audio/video content based on the user's actions in step 403, and sends the tagged audio/video content for storage in the Media Repository 263 for liter use in step 405.

The core of the tagging system 100 is the tagging engine 105 sub-system. As mention above and depicted in FIG. 2, the tagging engine 105 sub-system can include a Tagging Controls Manager 231, a Tag Table Builder/Searching unit 233, a Tag Lookup Table 235, a Tag Time Resolver 237, a Tagging Utilities/Libraries unit, a Tag Event Handler 241, and a Tag Internal State Machine 243.

The tagging engine 105 is not a stateless system. On the other hand, the tagging engine 105 is a finite state machine that is internally maintained to reflect the system states derived by the user's actions, and implemented by the Tag Internal State Machine 243.

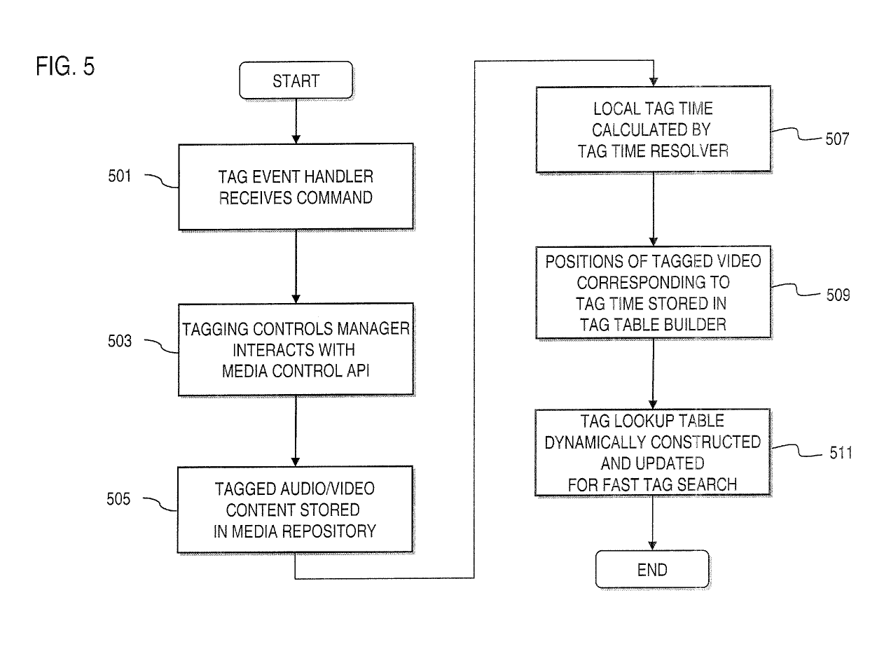

FIG. 5 provides a flowchart for the operation of the tagging engine 105. As described earlier, once the user event command from the CLE 107 is authorized and validated by the User API 101, then the queued VITAS command generated by the User API 101 sub-system is received and handled by the Tag Event Handler 241 in step 501 in conjunction with the Tagging Utilities/Libraries 239 and the Tagging Controls Manager 231. When user has requested the tagging of audio/video content (either in a live stream tagging mode or a recorded playback tagging mode), then the Tagging Controls Manager 231 interacts with the Media Control API 103 sub-system in step 503 to tag the audio/video content, and the tagged audio/video content is stored in the Media Repository 263 in step 505. The Tag Time Resolver 237 calculates the local tag time that correlates to and/or is derived from the real-time stamp carried in the content of the tagged audio/video in step 507. The positions of the tagged audio/video in the Media Repository 263 that correspond to the local tag time is compiled and built by the Tag Table Builder/Searching unit 233 in step 509. Additionally, an internal Tag Lookup Table 235 is dynamically constructed and updated using the information compiled by the Tag Table Builder/Searching unit 233 for fast tag searching and access in step 511. The table stored using the Tag Lookup Table 235 is stored and retrieved in a non-volatile storage. Thus, the user can quickly search stored tags for fast access and retrieval of tagged audio/video content.

The processes described herein for tagging of media content may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

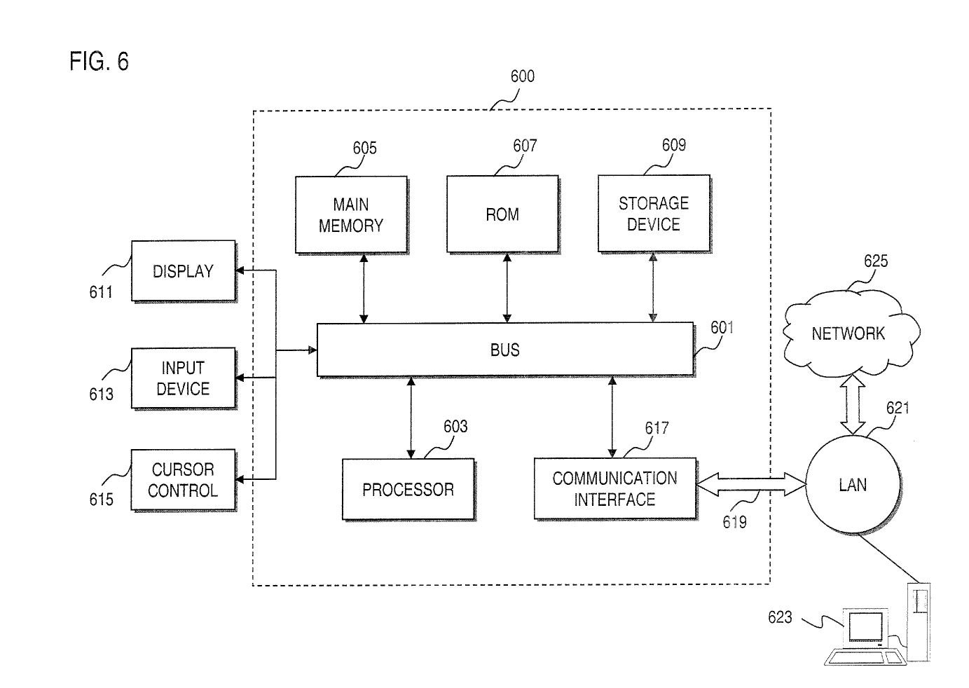

FIG. 6 illustrates computing hardware (e.g., computer system) 600 upon which an embodiment according to the invention can be implemented, such as the overall system or the tagging system 100 depicted in FIG. 2. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving a command from a user to request marking of media content; and
automatically inserting a tag into the media content in response to the received command,
wherein the media content can be accessed at a point specified by the tag.

2. The method according to claim 1, wherein the media content is automatically inserted based upon predetermined criteria.

3. The method according to claim 2, wherein the predetermined criteria is selected by the user from a list of criteria including timing information.

4. The method according to claim 1, wherein the media content is a live.

5. The method according to claim 1, wherein the tag includes descriptive information that is auto-populated, and/or is manually entered by a user.

6. The method according to claim 1, further comprising:
verifying whether the user is an authorized user, and whether the command is a valid command.

7. The method according to claim 1, further comprising:
determining a local tag time from the tagged media content; and
dynamically constructing a table including positions of the tagged media content.

8. The method according to claim 1, wherein the user can access and/or manipulate the media content associated with the tag using one or more commands including start tag, stop tag, save tag, purge tag, show tag menu, hide tag menu, show tag mosaic, show tag icons, hide tag icons, play tagged video/audio, stop tagged video/audio, copy tagged video/audio, play tagged video only, create tagged video/audio album, delete tagged video/audio album, create tagged snapshot album, and delete tagged snapshot album.

9. A method comprising:
receiving a command from a user to request marking of media content;
transmitting the command to a remote site where a tag is automatically inserted into the media content in response to the received command; and
accessing the media content at a point specified by the tag.

10. The method according to claim 9, wherein the user can access and/or manipulate the media content associated with the tag using one or more commands including start tag, stop tag, save tag, purge tag, show tag menu, hide tag menu, show tag mosaic, show tag icons, hide tag icons, play tagged video/audio, stop tagged video/audio, copy tagged video/audio, play tagged video only, create tagged video/audio album, delete tagged video/audio album, create tagged snapshot album, and delete tagged snapshot album.

11. An apparatus comprising:
a user interface configured to receive a command from a user;
a media control interface configured to be communicatively coupled to a multimedia system receiving a media content; and
a tagging engine communicatively coupled to the user interface and the media control interface,
wherein the tagging engine is configured to receive the command via the user interface, automatically insert a tag into the media content via the media control interface based on the command, and retrieve content in the tagged media content associated with the tag.

12. The apparatus according to claim 11, wherein the media control interface is configured to direct the tagged media content for storage.

13. The apparatus according to claim 11, wherein the media content is automatically inserted based upon predetermined criteria.

14. The apparatus according to claim 11, wherein the media content is a live.

15. The apparatus according to claim 11, wherein the tagging engine is configured to automatically include descriptive information with the tag.

16. The apparatus according to claim 11, wherein the tagging engine is configured to allow descriptive information to be manually entered by a user via the customer premise equipment.

17. The apparatus according to claim 11, wherein the user interface is configured to receive the command from a user corresponding to the tag, verify whether or not the user is an authorized user, and verify whether or not the command is a valid command.

18. The apparatus according to claim 11, wherein the tagging engine is configured to calculate a local tag time correlated to and/or derived from the tagged media content, store positions of the content of the tagged media content corresponding to the local tag time, and dynamically construct and update a table including the stored positions of the content of the tagged media content.

19. The apparatus according to claim 11, wherein the tagging engine is configured to access and/or manipulate the content in the tagged media content associated with the tag.

20. A system comprising:
a content server configured to store media content including video; and
a content tagging device configured to communicate with the content server and a media device that is configured to receive a command from a subscriber,
wherein the content tagging device is further configured to receive the command, to automatically insert a tag into the video content based on the command, and to retrieve content in the video content associated with the tag for playback to the subscriber.

21. The system according to claim 20, wherein the content server is further configured to access content from a plurality of content sources.

22. The system according to claim 20, wherein the media device includes a set-top box, a desktop computer, or a video game system.
